(19) United States
(12) Patent Application Publication
(10) Pub. No.: US 2026/0111712 A1
(43) Pub. Date: Apr. 23, 2026

(54) ENCODING FINITE STATE MACHINE CONVERSATION FLOWS FOR GENERATIVE ARTIFICIAL INTELLIGENCE MODELS

(71) Applicant: Salesforce, Inc., San Francisco, CA (US)

(72) Inventors: Akash Singh, Hyderabad (IN); Rajdeep Dua, Hyderabad (IN); Surbhi Pareek, Bangalore (IN); Mridula Priya, Bangalore (IN); Khyati Garg, Bangalore (IN)

(21) Appl. No.: 18/919,197

(22) Filed: Oct. 17, 2024

(51) Int. Cl. G06N 3/0475; G06F 40/35; G06N 3/096

(52) U.S. Cl. CPC G06N 3/0475; G06N 3/096; G06F 40/35

(57) ABSTRACT

A method may include finetuning a generative artificial intelligence (AI) model based on training data including finite state machine (FSM) conversation flows and corresponding intents. The method may include finetuning the generative AI model by tuning a set of base weights with a single set of weights that are based on the FSM conversation flows and the intents. The method may include receiving a query corresponding to an FSM conversation flow. The method may include determining that the first query contains a first intent associated with a first state of the FSM conversation flow. The method may include generating a first response to the first query that corresponds with the first state of the first FSM conversation flow. The method may include communicating commands to a service associated with the first FSM conversation flow, the commands corresponding with actions associated with the first intent and the first state.

### FIELD OF TECHNOLOGY

The present disclosure relates generally to database systems and data processing, and more specifically to encoding finite state machine conversation flows for generative artificial intelligence models.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

Some approaches to conversational bots may include the use of generative artificial intelligence (AI) models. However, such techniques may be improved.

### BRIEF DESCRIPTION OF THE DRAWINGS

FIG. 1 illustrates an example of a data processing system that supports encoding finite state machine conversation flows for generative artificial intelligence models in accordance with examples as disclosed herein.

FIG. 2 shows an example of a system that supports encoding finite state machine conversation flows for generative artificial intelligence models in accordance with examples as disclosed herein.

FIG. 3 shows an example of a finite state machine (FSM) conversation flow that supports encoding finite state machine conversation flows for generative artificial intelligence models in accordance with examples as disclosed herein.

FIG. 4 shows an example of an FSM conversation flow dataset scheme that supports encoding finite state machine conversation flows for generative artificial intelligence models in accordance with examples as disclosed herein.

FIG. 5 shows an example of an input and output structure that supports encoding finite state machine conversation flows for generative artificial intelligence models in accordance with examples as disclosed herein.

FIG. 6 shows an example of a finetuning dataset that supports encoding finite state machine conversation flows for generative artificial intelligence models in accordance with examples as disclosed herein.

FIG. 7 shows an example of a finetuning scheme that supports encoding finite state machine conversation flows for generative artificial intelligence models in accordance with examples as disclosed herein.

FIG. 8 shows an example of a system that supports encoding finite state machine conversation flows for generative artificial intelligence models in accordance with examples as disclosed herein.

FIG. 9 shows an example of a process flow that supports encoding finite state machine conversation flows for generative artificial intelligence models in accordance with examples as disclosed herein.

FIG. 10 shows a block diagram of an apparatus that supports encoding finite state machine conversation flows for generative artificial intelligence models in accordance with examples as disclosed herein.

FIG. 11 shows a block diagram of a generative AI manager that supports encoding finite state machine conversation flows for generative artificial intelligence models in accordance with examples as disclosed herein.

FIG. 12 shows a diagram of a system including a device that supports encoding finite state machine conversation flows for generative artificial intelligence models in accordance with examples as disclosed herein.

FIG. 13 shows a flowchart illustrating methods that support encoding finite state machine conversation flows for generative artificial intelligence models in accordance with examples as disclosed herein.

### DETAILED DESCRIPTION

Generative AI models are foundation models which can be used for a variety of natural language processing (NLP) tasks. Though generative AI models have given impressive results on many NLP tasks, generative AI models'knowledge may be restricted to data that they have seen in their training phase. For many enterprise use cases from specific domains like insurance, health care, and legal, the built-in knowledge of the generative AI model is insufficient. In such cases, finetuning is employed to impart task and domain specific knowledge to a generative AI model. However generative AI models are expensive models in terms of memory footprint and training compute. Thus, it is very expensive to finetune and maintain a separate generative AI model for each conversation flow of a different topic or domain.

Multiple finite state machines (FSMs) may be encoded into a single generative AI model by finetuning on curated FSM conversation flow datasets that include example FSM conversation flows and different points of the conversation flows may be associated with different intents. Once finetuned, a single generative AI model can be used to drive multiple FSM conversation flows, with each FSM conversation flow including a different FSM suited to the domain in which the FSM conversation flow is to be used. At runtime, a query is received from a chatbot for a particular FSM conversation flow, the generative AI model determines an intent of the query, and formulates a response based on the determined intent. In this way, the single generative AI model may handle queries for multiple workflows, instead of training or finetuning multiple, dedicated generative AI models to handle such queries.

In some examples, the generative AI model may be finetuned for multiple such FSM conversation flows, allowing the generative AI model to respond to queries in different contexts based on the different FSM conversation flows. In some examples, the finetuning may be performed with a single set of weights that may be applied to weights (e.g., base weights or frozen base weights) of the generative AI model, where the single set of weights includes weights for multiple FSM conversation flows. In some examples, the FSM conversation flow to be used may be identified by a context in which a conversation bot or other interface between a client and the generative AI model may be employed. In some examples, the generative AI model may determine that an intent of a received query is different than those of the FSM conversation flow, enter an error state, and, in some cases (e.g., if a threshold quantity of received intents do not correspond to intents of the FSM conversation flow), return to an initializing state. In some examples, the query may indicate an input that may trigger a transition to another state of the FSM conversation flow, which may also be associated with a different response to be provided to the client.

Aspects of the disclosure are initially described in the context of an environment supporting an on-demand database service. Aspects of the disclosure are then described with reference to a system, an FSM conversation flow, an FSM conversation flow scheme, an input and output structure, a finetuning dataset, a finetuning scheme, a system, and a process flow. Aspects of the disclosure are further illustrated by and described with reference to apparatus diagrams, system diagrams, and flowcharts that relate to encoding finite state machine conversation flows for generative artificial intelligence models.

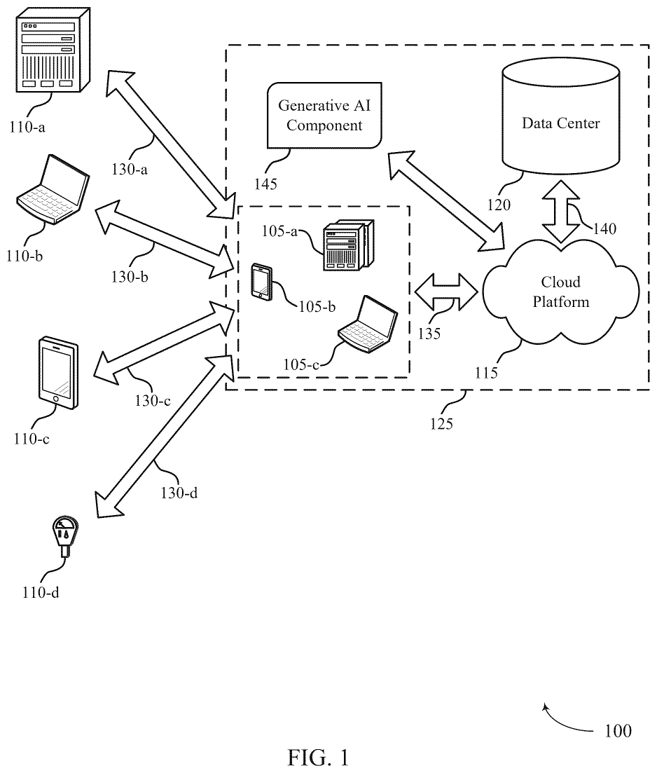

FIG. 1 illustrates an example of a system 100 for cloud computing that supports in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

Additionally, or alternatively, the system 100 may support the use of a large language model (generative AI model), such as the generative AI component 145. In some examples, a generative AI component 145 may also be referred to as any of an AI, a generative AI (GAI), a GAI model, a large language model (LLM). The generative AI component 145 may be a model that is trained on a corpus of input data, which may include text, images, video, audio, structured data, or any combination thereof. Such data may represent general-purpose data, domain-specific data, or any combination thereof. Further, a generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may transmit a prompt to the generative AI component 145 that includes the query (or information included therein) and receive the generated output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located outside of the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In some examples, the cloud platform 115 may communicate with the generative AI component 145 to provide responses and initiate actions to external services in response to input received from the cloud clients 105. In some examples, the cloud platform 115 may engage in training, finetuning, or both, of the generative AI component 145 based on multiple FSM conversation flows that include states and associated intents that may guide the interactions between the cloud clients 105 and the cloud platform 115.

In other approaches that utilize generative AI models to respond to user queries, many individual generative AI models are used to respond to different contexts, conversations, requests, or domains. Such use of multiple generative AI models is inefficient both in terms of preparing the generative AI models for use as well as at runtime, as one generative AI model may not be used for other situations or contexts outside of the narrow realm from which the generative AI model was designed. Training, maintenance, updating, and other management of such many generative AI models may become difficult, and the use of many such generative AI models may involve increased resource utilization (e.g., storage, processing, memory, bandwidth, or other resources).

By using the training and finetuning approaches described herein, a system may be used to train or finetune a single generative AI model with multiple FSM conversation flow so that the generative AI model may accurately respond for a variety of different contexts, domains, knowledge areas, or situations. For example, the finetuning may involve the use of a combined dataset that may include multiple FSM conversation flows that include multiple states and associated intents. The user inputs may be analyzed to determine an intent, and the determined intent may be compared to the intents of the FSM conversation flows to determine appropriate responses that are to be provided based on the states of the FSM conversation flow.

For example, an administrator may design or provide FSM conversation flows to be utilized in a variety of contexts, knowledge areas, or situations. The administrator may train the generative AI model and may further finetune the generative AI model by providing the generative AI model with a single set of weights (e.g., that are based on or include the FSM conversation flows) to finetune the generative AI model to better respond to all of the FSM conversation flows. At runtime, a user may interact with a chatbot or other interface for a given context that corresponds with an FSM conversation flow on which the generative AI model was finetuned. The user may provide inputs or queries that may be analyzed by the generative AI model to determine the intent of the user, match the intent with an intent of the FSM conversation flow, determine a corresponding state of the FSM conversation flow, and determine one or more responses that are to be provided to the user (e.g., based on responses included or indicated in the FSM conversation flow). Further the system may respond to the queries provided by the user by initiating one or more commands, actions, or operations associated with one or more services (internal or external), application programming interfaces (APIs), databases, storage, or other elements that may be associated with the FSM conversation flow, the intents or states thereof, the intent of the user, or any combination thereof.

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

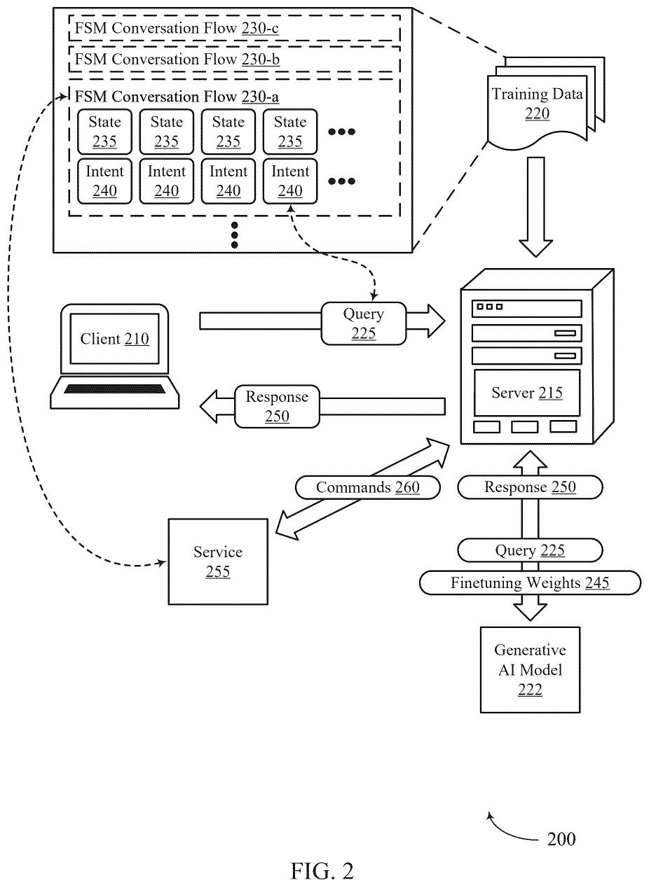

FIG. 2 shows an example of a system 200 that supports encoding finite state machine conversation flows for generative artificial intelligence models in accordance with examples as disclosed herein.

Generative AI models are foundational models which can be used for a variety of NLP tasks. Though such generative AI models have given impressive results on many NLP tasks, generative AI models'knowledge is restricted to data received in their training phase which is mostly commonly available datasets on internet or other sources. As such, for many use cases from specific domains (e.g., insurance, health care, legal, or others), the “built-in” knowledge is not sufficient.

In such cases, finetuning is employed to impart task and domain specific knowledge to generative AI model. Once finetuned, the generative AI model learns the new task and data thereby gives better result on the specific task but loses its generalization capabilities to other tasks. However, such approaches involve finetuning a single model per task. As generative AI models are expensive models in terms of resources, including memory, footprint, training, and compute resources. Thus, it can be very expensive to finetune and maintain a separate generative AI model one per workflow.

The techniques described herein include the use of FSMs to aid in encoding multiple sets of information in a single generative AI model 222 (e.g., finetuning the single generative AI model 222) that is capable of responding in multiple scenarios and contexts, thereby reducing the resource overhead and complexity as compared to training, finetuning, deploying, and maintaining multiple generative AI models on a one-to-one basis (e.g., one generative AI model for each of the various scenarios or contexts in which the multiple generative AI models are to be deployed). In particular, the single generative AI model 222 may be finetuned using curated workflow datasets that include information from multiple FSM conversation flows 230, such as the FSM conversation flow 230-a, the FSM conversation flow 230-b, and the FSM conversation flow 230-c, optionally among any quantity of additional FSM conversation flows.

The system 200 provides an example of how such techniques may be used. The system may include a server 215. The server 215 may represent a single server or processing entity, multiple servers or processing entities, a complete processing system, or any other entity capable of performing the operations described herein. The generative AI model 222 may be included as part of or otherwise associated with the server 215 or may operate independently of the server 215.

In some examples, the system 200 may train the generative AI model 222 based on one or more elements of the training data. In some examples, the training data 220 may include general training data (e.g., used to train a base model of the single generative AI model 222). The training data 220 may include multiple FSM conversation flows 230. The FSM conversation flows 230 may include or indicate multiple states 235 and intents 240, which may be used to guide progress through the FSM conversation flow 230 (e.g., in the course of responding to queries from the client 210, such as the query 225) and conditions under which such progress between states 235 may be made.

In some examples, the system 200 may finetune the single generative AI model 222 based on the training data. For example, the system 200 may provide example input-output pairs for the FSM conversation flows 230 (e.g., in a single dataset that includes such examples for multiple FSM conversation flows 230). In some examples, the finetuning may be performed by applying a single set of weights (e.g., the finetuning weights 245) to base weights of the single generative AI model 222 (e.g., in accordance with LoRA techniques). In some examples, the single set of weights may include or be based on one or more elements of the training data 220.

In some examples, the system 200 may receive the query 225 that may be associated with a conversation or interaction domain corresponding to an FSM conversation flow 230, such as the FSM conversation flow 230-a. In response the system 200 may determine (e.g., using the single generative AI model 222) that the query 225 indicates, is associated with, corresponds to, or includes an intent 240 that is included in or associated with the FSM conversation flow 230-a. For example, the query 225 may be fed to the single generative AI model 222 along with an instruction for the single generative AI model 222 to analyze the query 225 and determine whether the intent of the query 225 matched an intent 240 of the FSM conversation flow 230-a.

In some examples, the single generative AI model 222 may provide a response 250 that corresponds with the state 235, the intent 240, or both and the response 250 may be based on or in accordance with the FSM conversation flow 230-a. The system 200 may forward the response 250 (e.g., with formatting or other modifications) to the client 210.

In some examples, the server 215 may communicate with the service 255 (or multiple such services) to communicate one or more commands 260 that may be based on the FSM conversation flow 230-a, one or more elements thereof (e.g., a state 235, an intent 240, user input, state transitions, or any combination thereof). In some examples, the FSM conversation flows 230 may include instructions for the commands 260 that are to be transmitted or performed at one or more states 235 of the FSM conversation flow 230-a, and the commands 260 may be based on such instructions included in the FSM conversation flows 230.

In at least these ways, the system 200 may provide for training, finetuning, and operation of the generative AI model 222 that can effectively and efficiently respond to queries in a variety of contexts through the use of the FSM conversation flows 300 that are embedded in the single generative AI model 222 through the training or finetuning operations described herein.

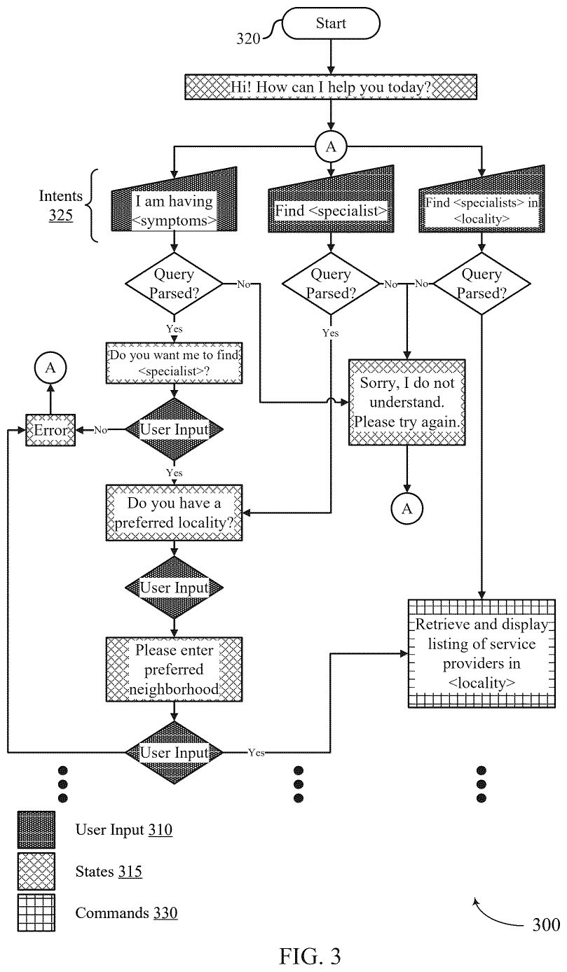

FIG. 3 shows an example of an FSM conversation flow 300 that supports in accordance with examples as disclosed herein. The FSM conversation flow 300 may include additional states 315, user inputs 310, intents 325, commands 330, or other elements not discussed or depicted here. Those that are included are examples and other elements may be added or included. Further, other FSM conversation flows may be considered for any context, knowledge domain, scenarios, or contexts, and multiple such FSM conversation flows may be employed to train or finetune a generative AI model.

FSMs are computation models that may be defined, at least in part, by a set of states. FSMs have a variety of applications including electrical engineering, logic and control flow, hardware digital systems, game design, computational linguistics, and many more. Here, they are being used to guide the conversation, processing, responses, external service calls, and other operations associated with generative AI models, and the FSMs may be expressed as FSM conversation flows, such as the FSM conversation flow 300.

In some settings, the FSM conversation flow 300 may be associated with or tied to a chat bot for a context, situation, knowledge domain, or use case. In such an arrangement, it may be desirable for the chat bot to respond to relevant queries and ignore other, irrelevant queries. Modeling a conversational workflow as an FSM conversation flow 300 helps to provide a conceptual framework to box the conversation flow and discourage the conversation from diverging.

In some examples, an FSM may be characterized by a finite set of states 315. A system following the FSM may be limited to being in a single state 315 at a given time, and transitions between states 315 are triggered by events, rules, user inputs 310, or any combination thereof.

Here, FSMs can be used to model conversational bots for specific contexts, workflows, situations, or implementations, and (e.g., as described herein) multiple such FSM conversation flows 300 may be employed to train or finetune a single generative AI model. In the FSM conversation flow 300 the bot responses may be represented by or are associated with the states 315 and a valid response from the user (e.g., a user input 310) triggers the transition from one state to another. This is achieved by associating a fixed quantity of “valid intents” which are recognized by a generative AI model. Once the generative AI model identifies a valid intent it generates the associated response, and sends the conversation flow to next valid state.

Here, FSM conversation flow 300 is an example of a portion of an FSM conversation flow used to model the conversation flow for a healthcare business workflow of scheduling a doctor appointment. Here, the FSM conversation flow 300 includes bot responses for each of the states 315 and portions in which user input is to be received, which may affect which branches or paths through the FSM conversation flow 300 are traveled during the course of the interaction.

In some examples, the FSM conversation flow 300 may begin with an initializing state 320 (e.g., represented by Start), after which an initial response may be provided (e.g., represented by “Hi! How can I help you today?”). At point A, the user may provide various types of input, three of which are represented by the inputs of “I am having <symptoms>”, “Find <specialist>” and “Find <specialists> in <locality>”. Many other user inputs may be possible here and at any point throughout the FSM conversation flow 300. These are included as non-limited examples. In some examples, <symptoms>, <specialist>, <locality> and other similar indications may be placeholders for items of the categories suggested by the placeholders themselves.

In the FSM conversation flows, each state may be associated with one or more specific user inputs 310 that may trigger transitions between states 315. If an incorrect trigger (e.g., for a given state 315) is received, the system allows a quantity of repeated attempts to meet the trigger with user input. If this fails, the system may “reset” the FSM conversation flow 300 to the start or initialization states 320. Similarly if a user inputs an irrelevant query, the generative AI model may be trained or finetuned to map the irrelevant query to an “unknown intent” or “irrelevant intent.” Again, the system may allow a quantity of repeated attempts, after which, if the user does not provide an input mapping to one of the valid intents 325, the FSM conversation flow 300 is reset and returns to the initializing state 320.

For example, in some cases, the generative AI model receiving the user inputs may parse the user input and determine what the intent of the user input is and whether it matches with the intents 325 indicated in the FSM conversation flow 300. If the query is parsed or matches the intents 325. If not, a state transition may be triggered, and the state 315 may transition to the state 315 with the response of “Sorry, I do not understand. Please try again” after which another state transition may take place back to point A.

In some examples, if enough queries are not able to be parsed (e.g., a threshold amount of queries are not properly parsed or intents of the user inputs do not match the intents 325 of the FSM conversation flow 300 a threshold quantity of times) or if the FSM conversation flow 300 otherwise indicates (e.g., the user indicates that she does not want the system to find a specialist), the system may enter the error state, and may then return back to point A.

In some examples, the FSM conversation flow 300 may include one or more commands 330 that are to be transmitted to one or more services (e.g., external or internal) in response to arriving at that point in the FSM conversation flow 300. For example, in response to arriving at the command 330 indicating “Retrieve and display listing of service providers in <locality>”, the system may transmit one or more commands to a service to retrieve information about service providers in the locality from the service. In response to receiving the information, the system may provide the retrieved information, optionally along with a response provided by the generative AI model that informs the client or user that the information has been retrieved and introduces such information.

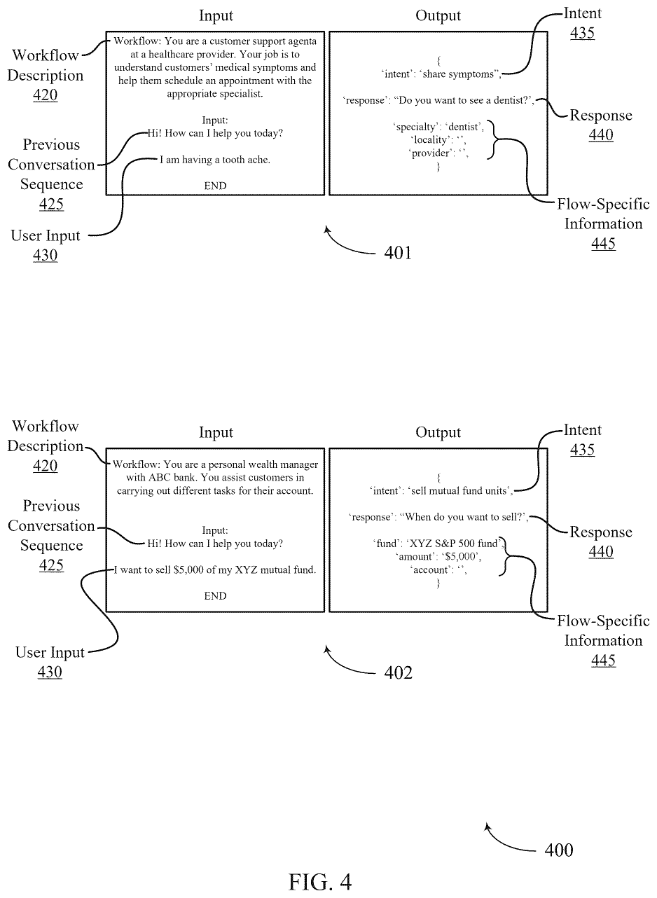

FIG. 4 shows an example of an FSM conversation flow dataset scheme 400 that supports encoding finite state machine conversation flows for generative artificial intelligence models in accordance with examples as disclosed herein. In the conversation flow dataset scheme 400, a dataset may include various inputs and outputs for different FSM conversation flows. For example, the FSM conversation flow data 401 may include an input and an output for a medical context and understanding a patient's symptoms and performing appropriate actions as a result. In another example, the FSM conversation flow data 402 may include an input and an output for a wealth management context in which a user desires to modify an aspect of her wealth management.

In each of the FSM conversation flow data 401 and the FSM conversation flow data 402, the input may include a workflow description 420, a previous conversation sequence 425, and user input 430 received from the user or client. Similarly, in each of the FSM conversation flow data 401 and the FSM conversation flow data 402, the output may include an intent 435, a response 440, and flow-specific information 445. In some examples, the flow-specific information 445 may include named entities, such as a service name or identifier, a locality, a service provider, an account number, other information that is associated with the FSM conversation flow or associated operations, or any combination thereof. In some examples, the flow-specific information 445 may include information that is used as one or more inputs to one or more FSM conversation flows.

In some examples, after designing the FSM conversation flows, the training datasets for training or finetuning the generative AI model may be generated. Creation of the training datasets or operation based on these training datasets may include various operations, including encoding the FSM conversation flows into the generative AI model, encoding multiple FSM conversation flows into a single generative AI model to handle different conversational contexts, understanding or interpreting user intents, named entity recognition, reasoning capabilities, one or more other operations, or any combination thereof.

In some examples, a system may encode the FSM conversation flows into the generative AI model. To achieve this, the system may ensure or encourage that the input to the generative AI model includes the workflow description 420, which identifies the FSM conversation flow that is to be applied as well as a description of the task that the generative AI model is to perform. This workflow description 420 serves to assign a role to the generative AI model and explains the workflow task. This helps the generative AI model to learn different tasks while being finetuned. Additionally, or alternatively, the system may ensure or encourage that the input to the generative AI model includes the previous conversation sequence 425 as well as the user input 430, (e.g., rather than just the user input 430 alone). This previous conversation sequence 425 represents the current state of the system.

In some examples, the generative AI model may also be used to interpret or understand the user's intent that may be included or indicated (either directly or indirectly) in the user input 430. For example, the generative AI model may map the user input 430 to one of the discrete user intents defined for a given FSM conversation flow. Recognizing the user intent correctly, together with having the conversation sequence as inputs, orients the generative AI model and helps it to recognize the current state in the workflow context and trigger the correct state transitions (e.g., based on satisfying one or more trigger conditions associated with a given state).

The output is also constructed to include a determined intent 435 of the user that matches an intent of the FSM conversation flow, the response 440 to be shown to the user, and any flow-specific information 445 that may be used for further processing or operations. In some examples, the response 440 represents the new state of the system, after receiving and processing the user input 430. This setup encourages the generative AI models to learn the state transitions of the FSM and learns to handle the business workflow.

In some examples, the system may train the generative AI model to recognize the flow-specific information 445 that may be used for further processing, such as to send one or more commands or perform one or more actions (e.g., in association with one or more services, databases, APIs, or other operations). For example, in the context of scheduling doctor appointments of FSM conversation flow data 401, relevant entities may include a specialty, a locality, or a particular provider. Similarly, in the context of the wealth management of FSM conversation flow data 402, the flow-specific information 445 may include a fund, an amount, and an account identifier. Though these examples of flow-specific information 445 are provided, other types of flow-specific information 445 are possible and may vary depending on the particular context (e.g., which FSM conversation flow is being used) or particular conversations (e.g., based on different user inputs 430). In some examples, the flow-specific information that is recognized, included in the output, or otherwise processed may depend on various factors, including the FSM conversation flow, a state of the FSM conversation flow, an intent of the FSM conversation flow, user inputs 430, responses 440, intents of the user put 430, intents of the FSM conversation flow, a matched intent 435 included in the output, one or more other elements or information described herein, or any combination thereof.

Further, in some examples, the generative AI model may use its reasoning capabilities (e.g., based on the “pre-built” knowledge or generalization capabilities of the generative AI model). To prevent or discourage this loss of knowledge, the generative AI models may be trained on multiple workflow specific tasks. For example, in the scenario of scheduling a doctor appointment, the generative AI model may be used to map the patient symptoms to the medical specialty. For example, given the user input: “I have an ear infection,” the generative AI model may correctly identify the specialty as Ear Nose Throat. Described more generally, the generative AI model may be used to identify one or more elements of the flow-specific information 445.

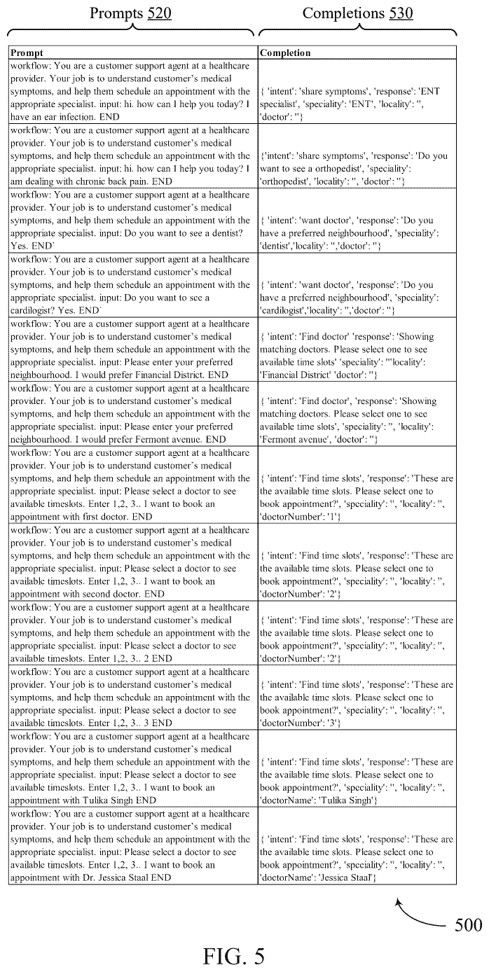

FIG. 5 shows an example of an input and output structure 500 that supports in accordance with examples as disclosed herein. The example input and output structure 500 may include prompts 520 and completions 530 (e.g., outputs) that may be used as a portion of a training or finetuning dataset for training or finetuning a generative AI model. The prompts 520 may include one or more of the same elements as the inputs described with reference to the dataset scheme 400, including the workflow description 420, the previous conversation sequence 425, and the user input 430. similarly, the completions 530 may include one or more of the same elements as the outputs described with reference to the dataset scheme 400, including the intent 435, the response 440, and the flow-specific information 445. The input and output structure 500 is an example of various such input and output pairs, described here as prompts 520 and completions 530.

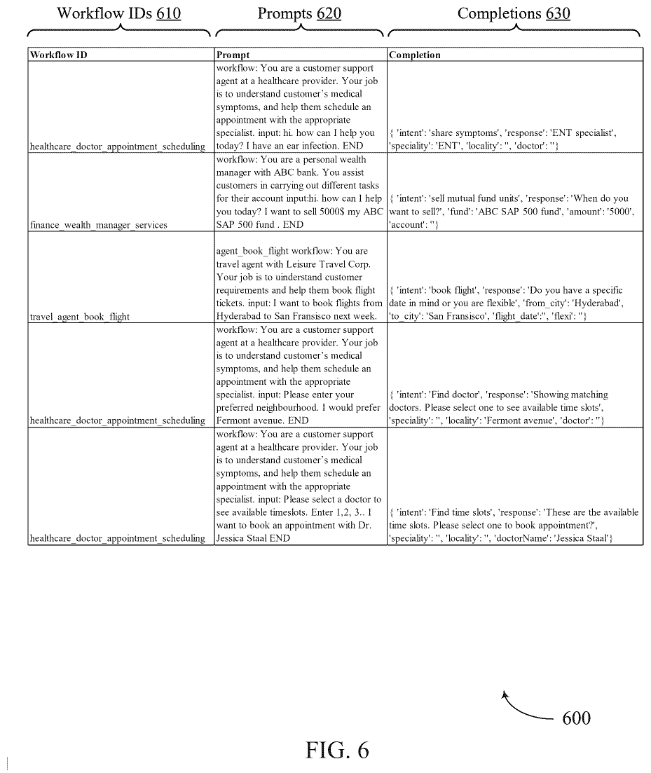

FIG. 6 shows an example of a finetuning dataset 600 that supports encoding finite state machine conversation flows for generative artificial intelligence models in accordance with examples as disclosed herein.

One main challenge with finetuning generative AI models for the use cases as described herein is the scarcity of training data. In some approaches, one can create a small quantity of examples manually and may be sufficient to finetune a single model for a single context, situation, knowledge domain, or use case. However, such approaches are inadequate when finetuning a single generative AI model to handle multiple contexts, situations, knowledge domains, or use cases. To encourage such efficiency and accurate finetuning, the generative AI model may be finetuned with a large quantity of samples (e.g., 1000 or more) for each context, situation, knowledge domain, or use case.

In some examples, to obtain quantities of samples, a set of “seed” examples may first be generated, after which one or more generative AI models may be used to generate further examples that are similar but different to the “seed” examples. For example, multiple of the initial or “seed” examples may be provided to the generative AI model (e.g., that include at least one example for each state of an FSM conversation flow) along with a prompt instructing the generative AI model generate additional examples that are to be added to a dataset (e.g., the finetuning dataset 600).

The example finetuning dataset 600 may include workflow identifiers (IDs), such as the workflow IDs 610, prompts 620, and completions 630 (e.g., outputs) that may be used as a portion of a training or finetuning dataset for training or finetuning a generative AI model. The prompts 620 may include one or more of the same elements as the inputs described with reference to the dataset scheme 400, including the workflow description 420, the previous conversation sequence 425, and the user input 430. similarly, the completions 630 may include one or more of the same elements as the outputs described with reference to the dataset scheme 400, including the intent 435, the response 440, and the flow-specific information 445. The finetuning dataset 600 is an example of various such input and output pairs, described here as prompts 620 and completions 620. However, as compared to the input and output structure 500, the finetuning dataset 600 may include the workflow IDs 610, which may aid in training or finetuning the generative AI model to recognize the FSM conversation flows based on the workflow IDs 610.

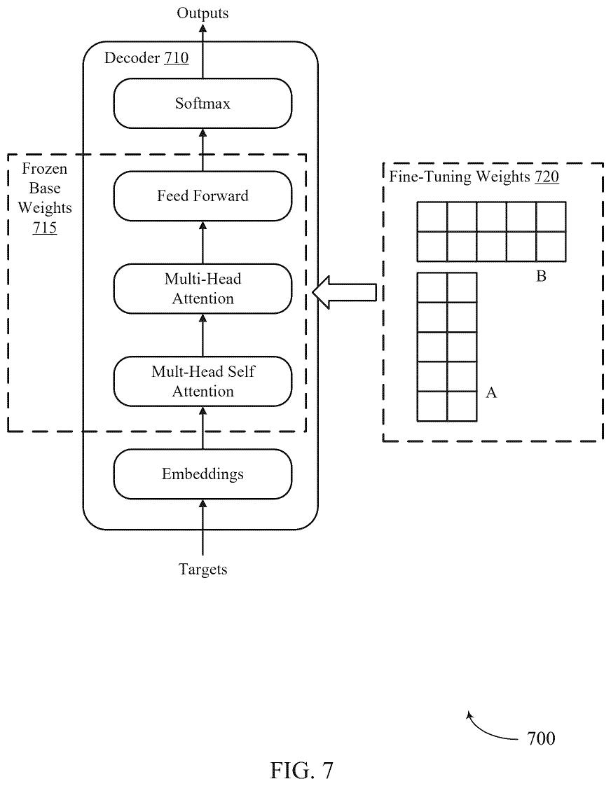

FIG. 7 shows an example of a finetuning scheme 700 that supports encoding finite state machine conversation flows for generative artificial intelligence models in accordance with examples as disclosed herein.

The finetuning scheme 700 may employ LoRA techniques to finetune the generative AI model. However, instead of using multiple pairs of LoRA weights (e.g., one pair of LoRA weights for each individual FSM conversation flow for which the generative AI model is to be finetuned), a single pair of fine-tuning weights 720 are applied to the frozen base weights 715 of a generative AI model.

For example, the frozen base weights 715 of the decoder 710 of the generative AI model are, as the designation implies, completely frozen and are not updated during training and instead, only the low rank matrices A*B are trained. In contrast to other approaches in which a different pair of LoRA weights are trained for each use case, a single set of LoRA weights (e.g., the fine-tuning weights 720) are trained and the generative AI model is finetuned.

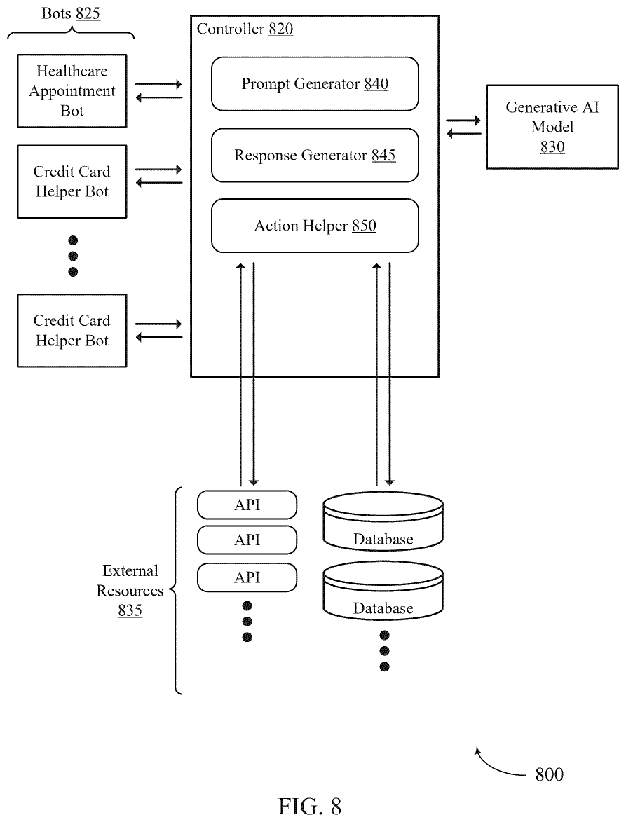

FIG. 8 shows an example of a system 800 that supports encoding finite state machine conversation flows for generative artificial intelligence models in accordance with examples as disclosed herein.

In some examples, at runtime, the generative AI model 830 (e.g., that has been trained and finetuned as described herein) may be used to drive conversation across multiple bots 825. Each bot 825 is being used in a particular context, situation, FSM conversation workflow, or scenario which is already known.

For example, a bot 825 may receive a query and transmit the query to the controller 820. The controller 820, using the prompt generator 840, may generate the prompt, which may include an indication of the workflow, a description of the workflow, a description of the task that the generative AI model 830 is to perform, any past conversation sequence, the user's input, or any combination thereof. The controller 820 may provide the assembled prompt to the generative AI model 830. The generative AI model 830 may process the prompt and provide a response, which may include an indication of an identified intent, a response to be provided to the user, one or more workflow-specific (e.g., FSM conversation flow-specific) information indications, or any combination thereof. The controller 820, using the response generator 845, may provide an assembled response (e.g., that may include one or more elements of the response from the generative AI model 830) to the bot 825, which may in turn provide the assembled response to the user. In some examples, the controller 820 may communicate with one or more external resources 835 (or other resources) to perform one or more actions, commands, or operations based on a state or state transition of the FSM conversation flow (e.g., which may indicate the actions, commands, or operations to be performed). In some examples, such actions, commands, or operations may be performed or transmitted via the action helper 850, and any information, communications, or operations received back from the external resources 835 may be received by the action helper 850, and any follow-up or subsequent actions may be handled by the controller 820, optionally using the action helper 850.

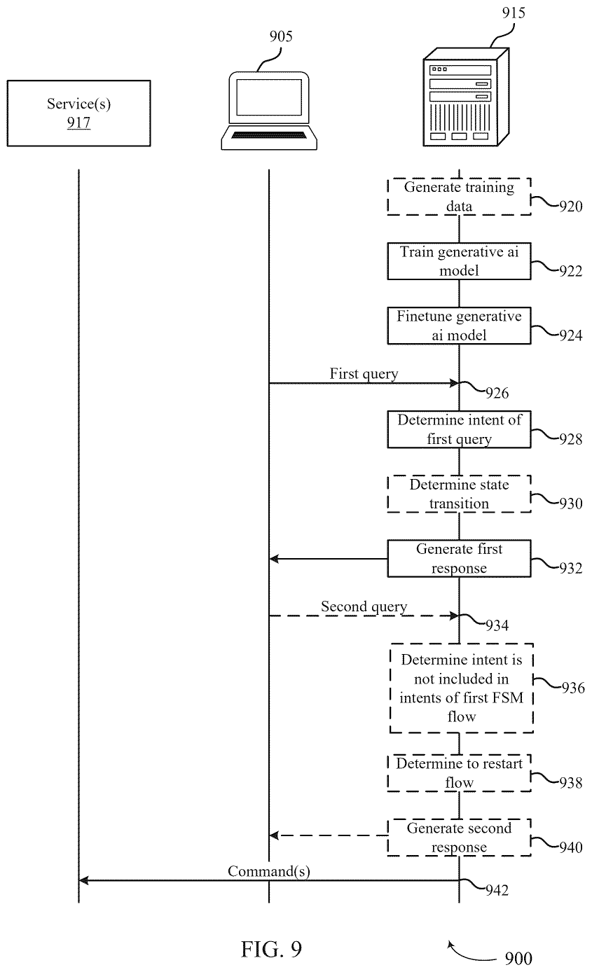

FIG. 9 shows an example of a process flow 900 that supports encoding finite state machine conversation flows for generative artificial intelligence models in accordance with examples as disclosed herein.

The process flow 900 may implement various aspects of the present disclosure described herein. The elements described in the process flow 900 (e.g., application server 915, client 905, and service(s) 917) may be examples of similarly named elements described herein.

In the following description of the process flow 900, the operations between the various entities or elements may be performed in different orders or at different times. Some operations may also be left out of the process flow 900, or other operations may be added.

Although the various entities or elements are shown performing the operations of the process flow 900, some aspects of some operations may also be performed by other entities or elements of the process flow 900 or by entities or elements that are not depicted in the process flow, or any combination thereof.

At 920, the application server 915 may generate, via the generative AI model, at least a portion of the training data.

At 922, the application server 915 may train a generative AI model based on training data that may include a plurality of FSM conversation flows and respective pluralities of intents associated with respective FSM conversation flows of the plurality of FSM conversation flows. In some examples, the training data may include a single dataset that may include the plurality of FSM conversation flows and the respective pluralities of intents. In some examples, each FSM conversation flow may include a plurality of entries, each entry that may include a workflow identifier, a prompt that may include a workflow description and a user query, and an output that may include an intent indication, a response indication, and one or more conversation flow-specific indications.

At 924, the application server 915 may finetune the generative AI model via a low rank adaptation (LoRA process that tunes a set of base weights associated with the generative AI model with a single set of LoRA weights that is based on the plurality of FSM conversation flows and the respective pluralities of intents.

At 926, the application server 915 may receive a first query that is associated with a first conversation domain that corresponds to a first FSM conversation flow of the plurality of FSM conversation flows.

At 928, the application server 915 may determine, with the generative AI model, that the first query is indicative of a first intent of a first plurality of intents of the respective pluralities of intents and the first plurality of intents is associated with the first FSM conversation flow, and wherein the first intent is associated with a first state of the first FSM conversation flow.

At 930, the application server 915 may determine, based on determining that the first query is indicative of the first intent, to transition from a previous state of the first FSM conversation flow to the first state of the first FSM conversation flow.

At 932, the application server 915 may generate, with the generative AI model and based on the determination of the first intent and the first FSM conversation flow, a first response that is responsive to the first query that corresponds with the first state of the first FSM conversation flow. In some examples, to generate the first response, the application server 915 may provide the first query and an indication of the first FSM conversation flow to the generative AI model. In some examples, to generate the first response, the application server 915 may receive a response that is responsive to the first query and corresponds to the first state of the first FSM conversation flow. In some examples, generation of the first response is based on the transition from the previous state of the first FSM conversation flow to the first state of the first FSM conversation flow.

At 934, the application server 915 may receive a second query.

At 936, the application server 915 may determine, via the generative AI model, that the second query is indicative of a second intent different than the first plurality of intents.

At 938, the application server 915 may determine, based on the determination that the second intent is different than the first plurality of intents, to transition to an initializing state of the first FSM conversation flow.

At 940, the application server 915 may generate a second response that corresponds with the initializing state of the first FSM conversation flow.

At 942, the application server 915 may communicate, one or more commands to one or more service(s) 917 that are associated with the first FSM conversation flow, the one or more commands corresponding with one or more actions that are associated with the first intent and the first state of the first FSM conversation flow.

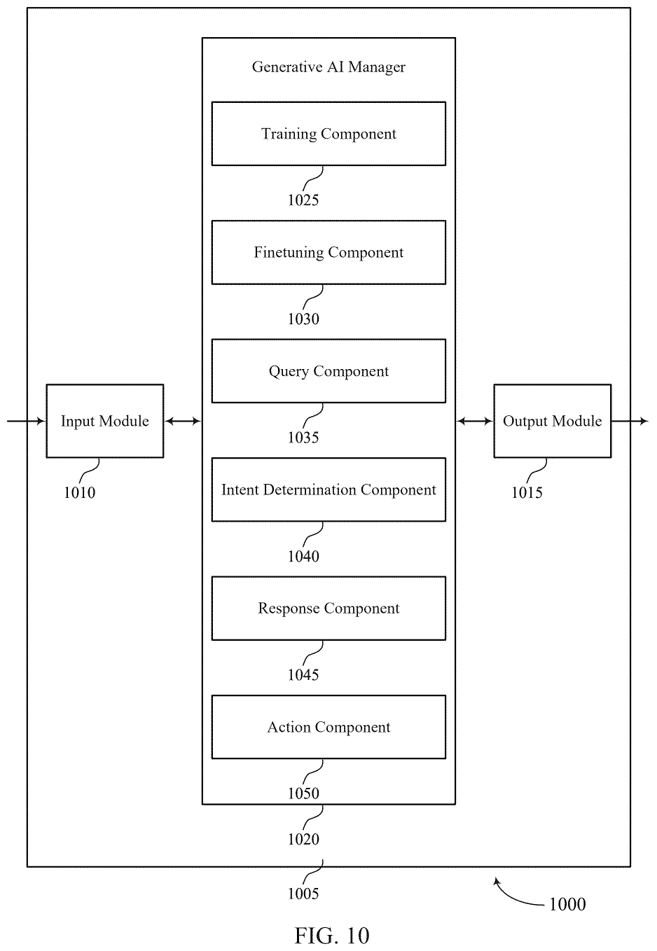

FIG. 10 shows a block diagram 1000 of a device 1005 that supports encoding finite state machine conversation flows for generative artificial intelligence models in accordance with examples as disclosed herein. The device 1005 may include an input module 1010, an output module 1015, and a generative AI manager 1020. The device 1005, or one or more components of the device 1005 (e.g., the input module 1010, the output module 1015, the generative AI manager 1020), may include at least one processor, which may be coupled with at least one memory, to support the described techniques. Each of these components may be in communication with one another (e.g., via one or more buses).

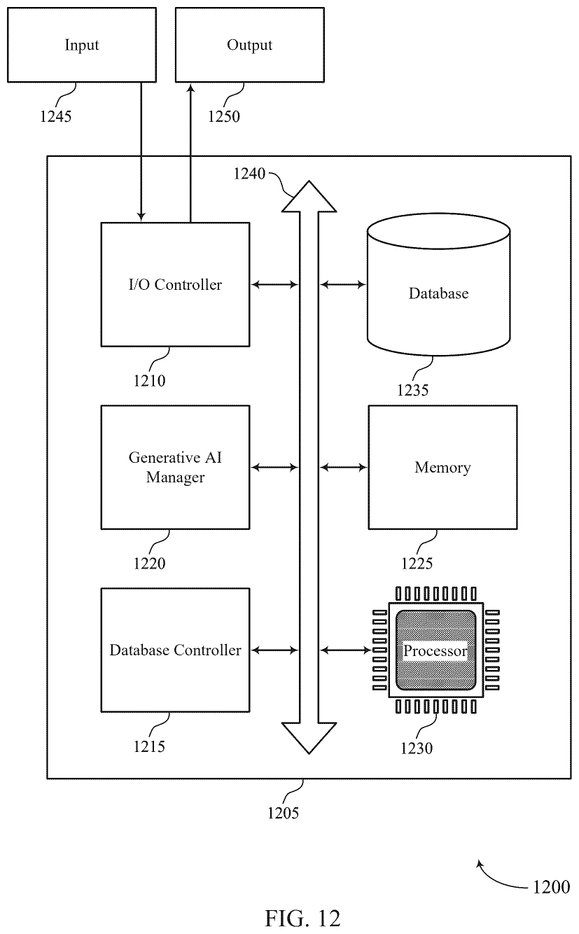

The input module 1010 may manage input signals for the device 1005. For example, the input module 1010 may identify input signals based on an interaction with a modem, a keyboard, a mouse, a touchscreen, or a similar device. These input signals may be associated with user input or processing at other components or devices. In some cases, the input module 1010 may utilize an operating system such as iOS®, ANDROID®, MS-DOS®, MS-WINDOWS®, OS/2®, UNIX®, LINUX®, or another known operating system to handle input signals. The input module 1010 may send aspects of these input signals to other components of the device 1005 for processing. For example, the input module 1010 may transmit input signals to the generative AI manager 1020 to support encoding finite state machine conversation flows for generative artificial intelligence models. In some cases, the input module 1010 may be a component of an input/output (I/O) controller 1210 as described with reference to FIG. 12.

The output module 1015 may manage output signals for the device 1005. For example, the output module 1015 may receive signals from other components of the device 1005, such as the generative AI manager 1020, and may transmit these signals to other components or devices. In some examples, the output module 1015 may transmit output signals for display in a user interface, for storage in a database or data store, for further processing at a server or server cluster, or for any other processes at any number of devices or systems. In some cases, the output module 1015 may be a component of an I/O controller 1210 as described with reference to FIG. 12.

For example, the generative AI manager 1020 may include a training component 1025, a finetuning component 1030, a query component 1035, an intent determination component 1040, a response component 1045, an action component 1050, or any combination thereof. In some examples, the generative AI manager 1020, or various components thereof, may be configured to perform various operations (e.g., receiving, monitoring, transmitting) using or otherwise in cooperation with the input module 1010, the output module 1015, or both. For example, the generative AI manager 1020 may receive information from the input module 1010, send information to the output module 1015, or be integrated in combination with the input module 1010, the output module 1015, or both to receive information, transmit information, or perform various other operations as described herein.

The generative AI manager 1020 may support data processing in accordance with examples as disclosed herein. The training component 1025 may be configured to support training a generative AI model based on training data that includes a set of multiple FSM conversation flows and respective pluralities of intents associated with respective FSM conversation flows of the set of multiple FSM conversation flows. Alternatively, or additionally, the finetuning component 1030 may be configured to support finetuning a generative AI model based on training data that includes a set of multiple FSM conversation flows and respective pluralities of intents associated with respective FSM conversation flows of the set of multiple FSM conversation flows. The finetuning component 1030 may be configured to support finetuning the generative AI model via a LoRA process that tunes a set of base weights associated with the generative AI model with a single set of LoRA weights that is based on the set of multiple FSM conversation flows and the respective pluralities of intents. The query component 1035 may be configured to support receiving a first query that is associated with a first conversation domain that corresponds to a first FSM conversation flow of the set of multiple FSM conversation flows. The intent determination component 1040 may be configured to support determining, with the generative AI model, that the first query is indicative of a first intent of a first set of multiple intents of the respective pluralities of intents, where the first set of multiple intents is associated with the first FSM conversation flow, and where the first intent is associated with a first state of the first FSM conversation flow. The response component 1045 may be configured to support generating, with the generative AI model and based on the determination of the first intent and the first FSM conversation flow, a first response that is responsive to the first query that corresponds with the first state of the first FSM conversation flow. The action component 1050 may be configured to support communicating, one or more commands to a service that is associated with the first FSM conversation flow, the one or more commands corresponding with one or more actions that are associated with the first intent and the first state of the first FSM conversation flow.

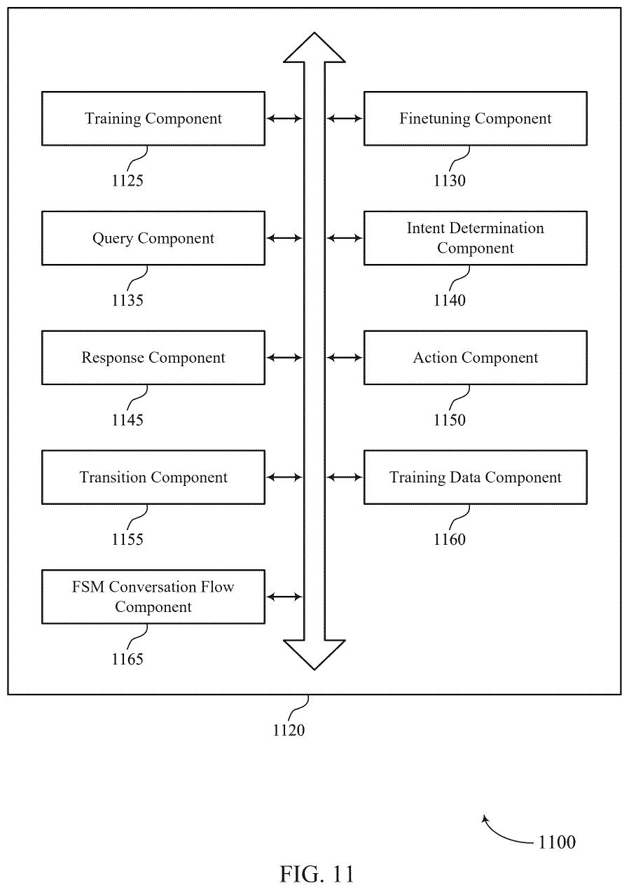

FIG. 11 shows a block diagram 1100 of a generative AI manager 1120 that supports encoding finite state machine conversation flows for generative artificial intelligence models in accordance with examples as disclosed herein. The generative AI manager 1120 may be an example of aspects of a generative AI manager or a generative AI manager 1020, or both, as described herein. The generative AI manager 1120, or various components thereof, may be an example of means for performing various aspects of encoding finite state machine conversation flows for generative artificial intelligence models as described herein. For example, the generative AI manager 1120 may include a training component 1125, a finetuning component 1130, a query component 1135, an intent determination component 1140, a response component 1145, an action component 1150, a transition component 1155, a training data component 1160, an FSM conversation flow component 1165, or any combination thereof. Each of these components, or components of subcomponents thereof (e.g., one or more processors, one or more memories), may communicate, directly or indirectly, with one another (e.g., via one or more buses).

The generative AI manager 1120 may support data processing in accordance with examples as disclosed herein. The training component 1125 may be configured to support training a generative AI model based on training data that includes a set of multiple FSM conversation flows and respective pluralities of intents associated with respective FSM conversation flows of the set of multiple FSM conversation flows. Additionally, or alternatively, the finetuning component 1130 may be configured to support training a generative AI model based on training data that includes a set of multiple FSM conversation flows and respective pluralities of intents associated with respective FSM conversation flows of the set of multiple FSM conversation flows. The finetuning component 1130 may be configured to support finetuning the generative AI model via a LoRA process that tunes a set of base weights associated with the generative AI model with a single set of LoRA weights that is based on the set of multiple FSM conversation flows and the respective pluralities of intents. The query component 1135 may be configured to support receiving a first query that is associated with a first conversation domain that corresponds to a first FSM conversation flow of the set of multiple FSM conversation flows. The intent determination component 1140 may be configured to support determining, with the generative AI model, that the first query is indicative of a first intent of a first set of multiple intents of the respective pluralities of intents, where the first set of multiple intents is associated with the first FSM conversation flow, and where the first intent is associated with a first state of the first FSM conversation flow. The response component 1145 may be configured to support generating, with the generative AI model and based on the determination of the first intent and the first FSM conversation flow, a first response that is responsive to the first query that corresponds with the first state of the first FSM conversation flow. The action component 1150 may be configured to support communicating, one or more commands to a service that is associated with the first FSM conversation flow, the one or more commands corresponding with one or more actions that are associated with the first intent and the first state of the first FSM conversation flow.

In some examples, to support generating the first response, the response component 1145 may be configured to support providing the first query and an indication of the first FSM conversation flow to the generative AI model. In some examples, to support generating the first response, the response component 1145 may be configured to support receiving a response that is responsive to the first query and corresponds to the first state of the first FSM conversation flow.

In some examples, the query component 1135 may be configured to support receiving a second query. In some examples, the intent determination component 1140 may be configured to support determining, via the generative AI model, that the second query is indicative of a second intent different than the first set of multiple intents. In some examples, the transition component 1155 may be configured to support determining, based on the determination that the second intent is different than the first set of multiple intents, to transition to an initializing state of the first FSM conversation flow. In some examples, the response component 1145 may be configured to support generating a second response that corresponds with the initializing state of the first FSM conversation flow.

In some examples, the transition component 1155 may be configured to support determining, based on determining that the first query is indicative of the first intent, to transition from a previous state of the first FSM conversation flow to the first state of the first FSM conversation flow. In some examples, the response component 1145 may be configured to support where generating the first response is based on the transition from the previous state of the first FSM conversation flow to the first state of the first FSM conversation flow.

In some examples, the training data component 1160 may be configured to support generating, via the generative AI model, at least a portion of the training data.

In some examples, the training data includes a single dataset that includes the set of multiple FSM conversation flows and the respective pluralities of intents.

In some examples, each FSM conversation flow includes a set of multiple entries, each entry including a workflow identifier, a prompt that includes a workflow description and a user query, and an output that includes an intent indication, a response indication, and one or more conversation flow-specific indications.

FIG. 12 shows a diagram of a system 1200 including a device 1205 that supports in accordance with examples as disclosed herein. The device 1205 may be an example of or include components of a device 1005 as described herein. The device 1205 may include components for bi-directional data communications including components for transmitting and receiving communications, such as a generative AI manager 1220, an I/O controller, such as an I/O controller 1210, a database controller 1215, at least one memory 1225, at least one processor 1230, and a database 1235. These components may be in electronic communication or otherwise coupled (e.g., operatively, communicatively, functionally, electronically, electrically) via one or more buses (e.g., a bus 1240).

The I/O controller 1210 may manage input signals 1245 and output signals 1250 for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. In other cases, the I/O controller 1210 may represent or interact with a modem, a keyboard, a mouse, a touchscreen, or a similar device. In some cases, the I/O controller 1210 may be implemented as part of a processor 1230. In some examples, a user may interact with the device 1205 via the I/O controller 1210 or via hardware components controlled by the I/O controller 1210.

The database controller 1215 may manage data storage and processing in a database 1235. In some cases, a user may interact with the database controller 1215. In other cases, the database controller 1215 may operate automatically without user interaction. The database 1235 may be an example of a single database, a distributed database, multiple distributed databases, a data store, a data lake, or an emergency backup database.

Memory 1225 may include random-access memory (RAM) and read-only memory (ROM). The memory 1225 may store computer-readable, computer-executable software including instructions that, when executed, cause at least one processor 1230 to perform various functions described herein. In some cases, the memory 1225 may contain, among other things, a basic I/O system (BIOS) which may control basic hardware or software operation such as the interaction with peripheral components or devices. The memory 1225 may be an example of a single memory or multiple memories. For example, the device 1205 may include one or more memories 1225.

The processor 1230 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 1230 may be configured to operate a memory array using a memory controller. In other cases, a memory controller may be integrated into the processor 1230. The processor 1230 may be configured to execute computer-readable instructions stored in at least one memory 1225 to perform various functions (e.g., functions or tasks supporting encoding finite state machine conversation flows for generative artificial intelligence models). The processor 1230 may be an example of a single processor or multiple processors. For example, the device 1205 may include one or more processors 1230.

The generative AI manager 1220 may support data processing in accordance with examples as disclosed herein. For example, the generative AI manager 1220 may be configured to support training or finetuning a generative AI model based on training data that includes a set of multiple FSM conversation flows and respective pluralities of intents associated with respective FSM conversation flows of the set of multiple FSM conversation flows. The generative AI manager 1220 may be configured to support finetuning the generative AI model via a LoRA process that tunes a set of base weights associated with the generative AI model with a single set of LoRA weights that is based on the set of multiple FSM conversation flows and the respective pluralities of intents. The generative AI manager 1220 may be configured to support receiving a first query that is associated with a first conversation domain that corresponds to a first FSM conversation flow of the set of multiple FSM conversation flows. The generative AI manager 1220 may be configured to support determining, with the generative AI model, that the first query is indicative of a first intent of a first set of multiple intents of the respective pluralities of intents, where the first set of multiple intents is associated with the first FSM conversation flow, and where the first intent is associated with a first state of the first FSM conversation flow. The generative AI manager 1220 may be configured to support generating, with the generative AI model and based on the determination of the first intent and the first FSM conversation flow, a first response that is responsive to the first query that corresponds with the first state of the first FSM conversation flow. The generative AI manager 1220 may be configured to support communicating, one or more commands to a service that is associated with the first FSM conversation flow, the one or more commands corresponding with one or more actions that are associated with the first intent and the first state of the first FSM conversation flow.

By including or configuring the generative AI manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

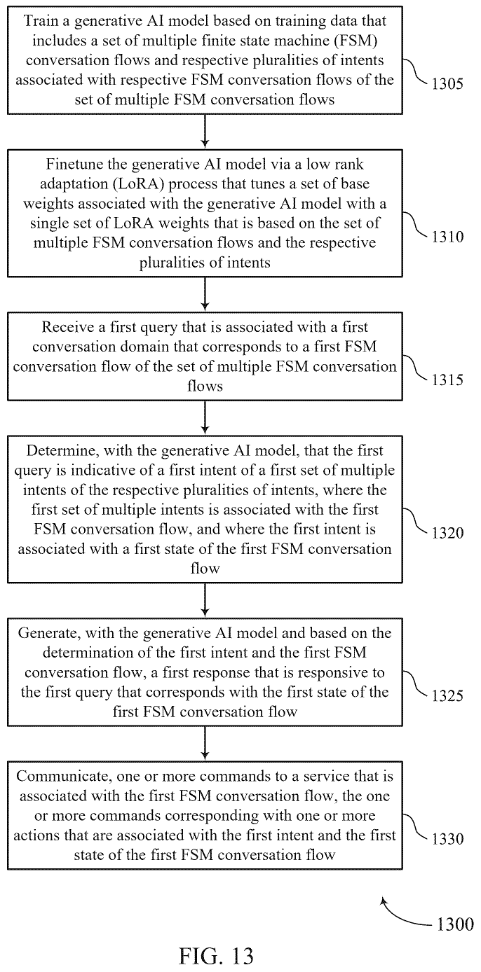

FIG. 13 shows a flowchart illustrating a method 1300 that supports encoding finite state machine conversation flows for generative artificial intelligence models in accordance with examples as disclosed herein. The operations of the method 1300 may be implemented by an Application Server or its components as described herein. For example, the operations of the method 1300 may be performed by an Application Server as described with reference to FIGS. 1 through 12. In some examples, an Application Server may execute a set of instructions to control the functional elements of the Application Server to perform the described functions. Additionally, or alternatively, the Application Server may perform aspects of the described functions using special-purpose hardware.

At 1305, the method may include finetuning a generative AI model based on training data that includes a set of multiple FSM conversation flows and respective pluralities of intents associated with respective FSM conversation flows of the set of multiple FSM conversation flows. The operations of 1305 may be performed in accordance with examples as disclosed herein. In some examples, aspects of the operations of 1305 may be performed by a training component 1125 as described with reference to FIG. 11.

At 1310, the method may include finetuning the generative AI model via a LoRA process that tunes a set of base weights associated with the generative AI model with a single set of LoRA weights that is based on the set of multiple FSM conversation flows and the respective pluralities of intents. The operations of 1310 may be performed in accordance with examples as disclosed herein. In some examples, aspects of the operations of 1310 may be performed by a finetuning component 1130 as described with reference to FIG. 11.

At 1315, the method may include receiving a first query that is associated with a first conversation domain that corresponds to a first FSM conversation flow of the set of multiple FSM conversation flows. The operations of 1315 may be performed in accordance with examples as disclosed herein. In some examples, aspects of the operations of 1315 may be performed by a query component 1135 as described with reference to FIG. 11.

At 1320, the method may include determining, with the generative AI model, that the first query is indicative of a first intent of a first set of multiple intents of the respective pluralities of intents, where the first set of multiple intents is associated with the first FSM conversation flow, and where the first intent is associated with a first state of the first FSM conversation flow. The operations of 1320 may be performed in accordance with examples as disclosed herein. In some examples, aspects of the operations of 1320 may be performed by an intent determination component 1140 as described with reference to FIG. 11.

At 1325, the method may include generating, with the generative AI model and based on the determination of the first intent and the first FSM conversation flow, a first response that is responsive to the first query that corresponds with the first state of the first FSM conversation flow. The operations of 1325 may be performed in accordance with examples as disclosed herein. In some examples, aspects of the operations of 1325 may be performed by a response component 1145 as described with reference to FIG. 11.

At 1330, the method may include communicating, one or more commands to a service that is associated with the first FSM conversation flow, the one or more commands corresponding with one or more actions that are associated with the first intent and the first state of the first FSM conversation flow. The operations of 1330 may be performed in accordance with examples as disclosed herein. In some examples, aspects of the operations of 1330 may be performed by an action component 1150 as described with reference to FIG. 11.

A method for data processing by an application server is described. The method may include finetuning a generative AI model based on training data that includes a set of multiple FSM conversation flows and respective pluralities of intents associated with respective FSM conversation flows of the set of multiple FSM conversation flows, finetuning the generative AI model via a low rank adaptation (LoRA) process that tunes a set of base weights associated with the generative AI model with a single set of LoRA weights that is based on the set of multiple FSM conversation flows and the respective pluralities of intents, receiving a first query that is associated with a first conversation domain that corresponds to a first FSM conversation flow of the set of multiple FSM conversation flows, determining, with the generative AI model, that the first query is indicative of a first intent of a first set of multiple intents of the respective pluralities of intents, where the first set of multiple intents is associated with the first FSM conversation flow, and where the first intent is associated with a first state of the first FSM conversation flow, generating, with the generative AI model and based on the determination of the first intent and the first FSM conversation flow, a first response that is responsive to the first query that corresponds with the first state of the first FSM conversation flow, and communicating, one or more commands to a service that is associated with the first FSM conversation flow, the one or more commands corresponding with one or more actions that are associated with the first intent and the first state of the first FSM conversation flow.

An application server for data processing is described. The application server may include one or more memories storing processor executable code, and one or more processors coupled with the one or more memories. The one or more processors may individually or collectively be operable to execute the code to cause the application server to train a generative AI model based on training data that includes a set of multiple FSM conversation flows and respective pluralities of intents associated with respective FSM conversation flows of the set of multiple FSM conversation flows, finetune the generative AI model via a low rank adaptation (LoRA) process that tunes a set of base weights associated with the generative AI model with a single set of LoRA weights that is based on the set of multiple FSM conversation flows and the respective pluralities of intents, receive a first query that is associated with a first conversation domain that corresponds to a first FSM conversation flow of the set of multiple FSM conversation flows, determine, with the generative AI model, that the first query is indicative of a first intent of a first set of multiple intents of the respective pluralities of intents, where the first set of multiple intents is associated with the first FSM conversation flow, and where the first intent is associated with a first state of the first FSM conversation flow, generate, with the generative AI model and based on the determination of the first intent and the first FSM conversation flow, a first response that is responsive to the first query that corresponds with the first state of the first FSM conversation flow, and communicate, one or more commands to a service that is associated with the first FSM conversation flow, the one or more commands corresponding with one or more actions that are associated with the first intent and the first state of the first FSM conversation flow.

Another application server for data processing is described. The application server may include means for finetuning a generative AI model based on training data that includes a set of multiple FSM conversation flows and respective pluralities of intents associated with respective FSM conversation flows of the set of multiple FSM conversation flows, means for finetuning the generative AI model via a low rank adaptation (LoRA) process that tunes a set of base weights associated with the generative AI model with a single set of LoRA weights that is based on the set of multiple FSM conversation flows and the respective pluralities of intents, means for receiving a first query that is associated with a first conversation domain that corresponds to a first FSM conversation flow of the set of multiple FSM conversation flows, means for determining, with the generative AI model, that the first query is indicative of a first intent of a first set of multiple intents of the respective pluralities of intents, where the first set of multiple intents is associated with the first FSM conversation flow, and where the first intent is associated with a first state of the first FSM conversation flow, means for generating, with the generative AI model and based on the determination of the first intent and the first FSM conversation flow, a first response that is responsive to the first query that corresponds with the first state of the first FSM conversation flow, and means for communicating, one or more commands to a service that is associated with the first FSM conversation flow, the one or more commands corresponding with one or more actions that are associated with the first intent and the first state of the first FSM conversation flow.

A non-transitory computer-readable medium storing code for data processing is described. The code may include instructions executable by one or more processors to train a generative AI model based on training data that includes a set of multiple FSM conversation flows and respective pluralities of intents associated with respective FSM conversation flows of the set of multiple FSM conversation flows, finetune the generative AI model via a low rank adaptation (LoRA) process that tunes a set of base weights associated with the generative AI model with a single set of LoRA weights that is based on the set of multiple FSM conversation flows and the respective pluralities of intents, receive a first query that is associated with a first conversation domain that corresponds to a first FSM conversation flow of the set of multiple FSM conversation flows, determine, with the generative AI model, that the first query is indicative of a first intent of a first set of multiple intents of the respective pluralities of intents, where the first set of multiple intents is associated with the first FSM conversation flow, and where the first intent is associated with a first state of the first FSM conversation flow, generate, with the generative AI model and based on the determination of the first intent and the first FSM conversation flow, a first response that is responsive to the first query that corresponds with the first state of the first FSM conversation flow, and communicate, one or more commands to a service that is associated with the first FSM conversation flow, the one or more commands corresponding with one or more actions that are associated with the first intent and the first state of the first FSM conversation flow.

In some examples of the method, application servers, and non-transitory computer-readable medium described herein, generating the first response may include operations, features, means, or instructions for providing the first query and an indication of the first FSM conversation flow to the generative AI model and receiving a response that may be responsive to the first query and corresponds to the first state of the first FSM conversation flow.

Some examples of the method, application servers, and non-transitory computer-readable medium described herein may further include operations, features, means, or instructions for receiving a second query, determining, via the generative AI model, that the second query may be indicative of a second intent different than the first set of multiple intents, determining, based on the determination that the second intent may be different than the first set of multiple intents, to transition to an initializing state of the first FSM conversation flow, and generating a second response that corresponds with the initializing state of the first FSM conversation flow.

Some examples of the method, application servers, and non-transitory computer-readable medium described herein may further include operations, features, means, or instructions for determining, based on determining that the first query may be indicative of the first intent, to transition from a previous state of the first FSM conversation flow to the first state of the first FSM conversation flow and where generating the first response may be based on the transition from the previous state of the first FSM conversation flow to the first state of the first FSM conversation flow.

Some examples of the method, application servers, and non-transitory computer-readable medium described herein may further include operations, features, means, or instructions for generating, via the generative AI model, at least a portion of the training data.

In some examples of the method, application servers, and non-transitory computer-readable medium described herein, the training data includes a single dataset that includes the set of multiple FSM conversation flows and the respective pluralities of intents.

In some examples of the method, application servers, and non-transitory computer-readable medium described herein, each FSM conversation flow includes a set of multiple entries, each entry including a workflow identifier, a prompt that includes a workflow description and a user query, and an output that includes an intent indication, a response indication, and one or more conversation flow-specific indications.

The following provides an overview of aspects of the present disclosure:

Aspect 1: A method for data processing at an application server, comprising: finetuning a generative AI model based at least in part on training data that comprises a plurality of FSM conversation flows and respective pluralities of intents associated with respective FSM conversation flows of the plurality of FSM conversation flows; finetuning the generative AI model via a low rank adaptation (LoRA) process that tunes a set of base weights associated with the generative AI model with a single set of LoRA weights that is based at least in part on the plurality of FSM conversation flows and the respective pluralities of intents; receiving a first query that is associated with a first conversation domain that corresponds to a first FSM conversation flow of the plurality of FSM conversation flows; determining, with the generative AI model, that the first query is indicative of a first intent of a first plurality of intents of the respective pluralities of intents, wherein the first plurality of intents is associated with the first FSM conversation flow, and wherein the first intent is associated with a first state of the first FSM conversation flow; generating, with the generative AI model and based at least in part on the determination of the first intent and the first FSM conversation flow, a first response that is responsive to the first query that corresponds with the first state of the first FSM conversation flow; communicating, one or more commands to a service that is associated with the first FSM conversation flow, the one or more commands corresponding with one or more actions that are associated with the first intent and the first state of the first FSM conversation flow.

Aspect 2: The method of aspect 1, wherein generating the first response comprises: providing the first query and an indication of the first FSM conversation flow to the generative AI model; and receiving a response that is responsive to the first query and corresponds to the first state of the first FSM conversation flow.

Aspect 3: The method of any of aspects 1 through 2, further comprising: receiving a second query; determining, via the generative AI model, that the second query is indicative of a second intent different than the first plurality of intents; determining, based at least in part on the determination that the second intent is different than the first plurality of intents, to transition to an initializing state of the first FSM conversation flow; and generating a second response that corresponds with the initializing state of the first FSM conversation flow.

Aspect 4: The method of any of aspects 1 through 3, further comprising: determining, based at least in part on determining that the first query is indicative of the first intent, to transition from a previous state of the first FSM conversation flow to the first state of the first FSM conversation flow; wherein generating the first response is based at least in part on the transition from the previous state of the first FSM conversation flow to the first state of the first FSM conversation flow.

Aspect 5: The method of any of aspects 1 through 4, further comprising: generating, via the generative AI model, at least a portion of the training data.

Aspect 6: The method of any of aspects 1 through 5, wherein the training data comprises a single dataset that comprises the plurality of FSM conversation flows and the respective pluralities of intents.

Aspect 7: The method of any of aspects 1 through 6, wherein each FSM conversation flow comprises a plurality of entries, each entry comprising a workflow identifier, a prompt that comprises a workflow description and a user query, and an output that comprises an intent indication, a response indication, and one or more conversation flow-specific indications.

Aspect 8: An application server for data processing, comprising one or more memories storing processor-executable code, and one or more processors coupled with the one or more memories and individually or collectively operable to execute the code to cause the application server to perform a method of any of aspects 1 through 7.

Aspect 9: An application server for data processing, comprising at least one means for performing a method of any of aspects 1 through 7.

Aspect 10: A non-transitory computer-readable medium storing code for data processing, the code comprising instructions executable by one or more processors to perform a method of any of aspects 1 through 7.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing at an application server, comprising:
finetuning a generative artificial intelligence (AI) model based at least in part on training data that comprises a plurality of finite state machine (FSM) conversation flows and respective pluralities of intents associated with respective FSM conversation flows of the plurality of FSM conversation flows;
finetuning the generative AI model via a low rank adaptation (LoRA) process that tunes a set of base weights associated with the generative AI model with a single set of LoRA weights that is based at least in part on the plurality of FSM conversation flows and the respective pluralities of intents;
receiving a first query that is associated with a first conversation domain that corresponds to a first FSM conversation flow of the plurality of FSM conversation flows;
determining, with the generative AI model, that the first query is indicative of a first intent of a first plurality of intents of the respective pluralities of intents, wherein the first plurality of intents is associated with the first FSM conversation flow, and wherein the first intent is associated with a first state of the first FSM conversation flow;
generating, with the generative AI model and based at least in part on the determination of the first intent and the first FSM conversation flow, a first response that is responsive to the first query that corresponds with the first state of the first FSM conversation flow; and
communicating, one or more commands to a service that is associated with the first FSM conversation flow, the one or more commands corresponding with one or more actions that are associated with the first intent and the first state of the first FSM conversation flow.

2. The method of claim 1, wherein generating the first response comprises:
providing the first query and an indication of the first FSM conversation flow to the generative AI model; and
receiving a response that is responsive to the first query and corresponds to the first state of the first FSM conversation flow.

3. The method of claim 1, further comprising:
receiving a second query;
determining, via the generative AI model, that the second query is indicative of a second intent different than the first plurality of intents;
determining, based at least in part on the determination that the second intent is different than the first plurality of intents, to transition to an initializing state of the first FSM conversation flow; and
generating a second response that corresponds with the initializing state of the first FSM conversation flow.

4. The method of claim 1, further comprising:
determining, based at least in part on determining that the first query is indicative of the first intent, to transition from a previous state of the first FSM conversation flow to the first state of the first FSM conversation flow, wherein generating the first response is based at least in part on the transition from the previous state of the first FSM conversation flow to the first state of the first FSM conversation flow.

5. The method of claim 1, further comprising:
generating, via the generative AI model, at least a portion of the training data.

6. The method of claim 1, wherein the training data comprises a single dataset that comprises the plurality of FSM conversation flows and the respective pluralities of intents.

7. The method of claim 1, wherein each FSM conversation flow comprises a plurality of entries, each entry comprising a workflow identifier, a prompt that comprises a workflow description and a user query, and an output that comprises an intent indication, a response indication, and one or more conversation flow-specific indications.

8. An application server for data processing, comprising:
one or more memories storing processor-executable code; and
one or more processors coupled with the one or more memories and individually or collectively operable to execute the code to cause the application server to:
finetune a generative artificial intelligence (AI) model based at least in part on training data that comprises a plurality of finite state machine (FSM) conversation flows and respective pluralities of intents associated with respective FSM conversation flows of the plurality of FSM conversation flows;
finetune the generative AI model via a low rank adaptation (LoRA) process that tunes a set of base weights associated with the generative AI model with a single set of LoRA weights that is based at least in part on the plurality of FSM conversation flows and the respective pluralities of intents;
receive a first query that is associated with a first conversation domain that corresponds to a first FSM conversation flow of the plurality of FSM conversation flows;
determine, with the generative AI model, that the first query is indicative of a first intent of a first plurality of intents of the respective pluralities of intents, wherein the first plurality of intents is associated with the first FSM conversation flow, and wherein the first intent is associated with a first state of the first FSM conversation flow;
generate, with the generative AI model and based at least in part on the determination of the first intent and the first FSM conversation flow, a first response that is responsive to the first query that corresponds with the first state of the first FSM conversation flow; and
communicate, one or more commands to a service that is associated with the first FSM conversation flow, the one or more commands corresponding with one or more actions that are associated with the first intent and the first state of the first FSM conversation flow.

9. The application server of claim 8, wherein, to generate the first response, the one or more processors are individually or collectively operable to execute the code to cause the application server to:
provide the first query and an indication of the first FSM conversation flow to the generative AI model; and
receive a response that is responsive to the first query and corresponds to the first state of the first FSM conversation flow.

10. The application server of claim 8, wherein the one or more processors are individually or collectively further operable to execute the code to cause the application server to:
receive a second query;
determine, via the generative AI model, that the second query is indicative of a second intent different than the first plurality of intents;
determine, based at least in part on the determination that the second intent is different than the first plurality of intents, to transition to an initializing state of the first FSM conversation flow; and
generate a second response that corresponds with the initializing state of the first FSM conversation flow.

11. The application server of claim 8, wherein the one or more processors are individually or collectively further operable to execute the code to cause the application server to:
determine, based at least in part on determining that the first query is indicative of the first intent, to transition from a previous state of the first FSM conversation flow to the first state of the first FSM conversation flow, wherein generation of the first response is based at least in part on the transition from the previous state of the first FSM conversation flow to the first state of the first FSM conversation flow.

12. The application server of claim 8, wherein the one or more processors are individually or collectively further operable to execute the code to cause the application server to:
generate, via the generative AI model, at least a portion of the training data.

13. The application server of claim 8, wherein the training data comprises a single dataset that comprises the plurality of FSM conversation flows and the respective pluralities of intents.

14. The application server of claim 8, wherein each FSM conversation flow comprises a plurality of entries, each entry comprising a workflow identifier, a prompt that comprises a workflow description and a user query, and an output that comprises an intent indication, a response indication, and one or more conversation flow-specific indications.

15. A non-transitory computer-readable medium storing code for data processing, the code comprising instructions executable by one or more processors to:
finetune a generative artificial intelligence (AI) model based at least in part on training data that comprises a plurality of finite state machine (FSM) conversation flows and respective pluralities of intents associated with respective FSM conversation flows of the plurality of FSM conversation flows;
finetune the generative AI model via a low rank adaptation (LoRA) process that tunes a set of base weights associated with the generative AI model with a single set of LoRA weights that is based at least in part on the plurality of FSM conversation flows and the respective pluralities of intents;
receive a first query that is associated with a first conversation domain that corresponds to a first FSM conversation flow of the plurality of FSM conversation flows;
determine, with the generative AI model, that the first query is indicative of a first intent of a first plurality of intents of the respective pluralities of intents, wherein the first plurality of intents is associated with the first FSM conversation flow, and wherein the first intent is associated with a first state of the first FSM conversation flow;
generate, with the generative AI model and based at least in part on the determination of the first intent and the first FSM conversation flow, a first response that is responsive to the first query that corresponds with the first state of the first FSM conversation flow; and
communicate, one or more commands to a service that is associated with the first FSM conversation flow, the one or more commands corresponding with one or more actions that are associated with the first intent and the first state of the first FSM conversation flow.

16. The non-transitory computer-readable medium of claim 15, wherein the instructions to generate the first response are executable by the one or more processors to:
provide the first query and an indication of the first FSM conversation flow to the generative AI model; and
receive a response that is responsive to the first query and corresponds to the first state of the first FSM conversation flow.

17. The non-transitory computer-readable medium of claim 15, wherein the instructions are further executable by the one or more processors to:
receive a second query;
determine, via the generative AI model, that the second query is indicative of a second intent different than the first plurality of intents;
determine, based at least in part on the determination that the second intent is different than the first plurality of intents, to transition to an initializing state of the first FSM conversation flow; and
generate a second response that corresponds with the initializing state of the first FSM conversation flow.

18. The non-transitory computer-readable medium of claim 15, wherein the instructions are further executable by the one or more processors to:
determine, based at least in part on determining that the first query is indicative of the first intent, to transition from a previous state of the first FSM conversation flow to the first state of the first FSM conversation flow, wherein generating the first response is based at least in part on the transition from the previous state of the first FSM conversation flow to the first state of the first FSM conversation flow.

19. The non-transitory computer-readable medium of claim 15, wherein the instructions are further executable by the one or more processors to:
generate, via the generative AI model, at least a portion of the training data.

20. The non-transitory computer-readable medium of claim 15, wherein the training data comprises a single dataset that comprises the plurality of FSM conversation flows and the respective pluralities of intents.
